(19) United States
(12) Patent Application Publication
(10) Pub. No.: US 2025/0323598 A1
(43) Pub. Date: Oct. 16, 2025

(54) SOLAR ENERGY SYSTEM

(71) Applicant: Idealab Studio, LLC, Pasadena, CA (US)

(72) Inventors: Andrea Pedretti, Thousand Oaks, CA (US); William Tod Gross, Pasadena, CA (US)

(21) Appl. No.: 19/176,659

(22) Filed: Apr. 11, 2025

Related U.S. Application Data
(60) Provisional application No. 63/633,005, filed on Apr. 11, 2024.

(51) Int. Cl. H02S 20/32; G01S 3/786; H02S 30/10; H02S 40/10; H02S 40/38

(52) U.S. Cl. CPC H02S 20/32; G01S 3/7861; H02S 30/10; H02S 40/10; H02S 40/38

(57) ABSTRACT

A standalone solar energy unit that can be installed on a ground surface includes a base and a housing vertically above and rotatably coupled to the base. The housing has a storage chamber extending to an opening. A cover is coupled to housing over the opening and movable between an open position allowing access to the storage chamber and a closed position to close the opening. The unit has a pair of arms that can move between an extended position out of the storage chamber and a retracted position within the storage chamber. Photovoltaic solar panel(s) are pivotally coupled to the pair of arms. The unit has a controller operable to move the housing and the photovoltaic solar panels to track the sun. The photovoltaic solar panels are electrically connected to a battery, which can store electricity generated by the photovoltaic solar panels.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure is directed to a solar energy system, and more particularly to a system for capturing, storing, and delivering solar power using prefabricated and free-standing solar energy units.

### Description of the Related Art

There is an increased interest in using renewable energy and particularly solar energy in a residential environment. Photovoltaic panels have been installed on homes and buildings to generate electricity. However, such panels require construction on a home (e.g., a roof) to install the panels, the systems are complex and require hiring a trained installation crew, and energy storage is separate from energy collection units and require separate installation.

### SUMMARY

Accordingly, there is a need for an improved solar energy system that is easy to install and operate, that does not require a trained crew of people to install, and that can be installed in a backyard or patio of a home or business.

In accordance with one aspect of the disclosure, a prefabricated and free-standing solar energy unit is provided. The unit can be installed on a ground surface (e.g., patio, backyard) and includes a base and a housing vertically above and rotatably coupled to the base. The housing has a storage chamber extending to an opening. A cover is coupled to housing over the opening and movable between an open position allowing access to the storage chamber and a closed position to close the opening. A battery housed in the storage chamber. The unit has a pair of arms that can move between an extended position out of the storage chamber and a retracted position within the storage chamber. Photovoltaic solar panel(s) have opposite ends pivotally coupled to the pair of arms via pivot joints. The unit has a controller operable to move the housing and the photovoltaic solar panels to track the sun. The controller can rotate the housing relative to the base to track an azimuth position of the sun and/or rotate the photovoltaic solar panels about the pivot joints when the arms are in the extended position to track an elevation position of the sun. The photovoltaic solar panels are electrically connected to the battery, which can store electricity generated by the photovoltaic solar panels.

In accordance with another aspect of the disclosure, a solar energy system is provided that includes multiple solar energy units, the system configured to power a home and/or charge an electric vehicle. The units can be installed on a ground surface (e.g., patio, backyard). Each unit includes a base and a housing vertically above and rotatably coupled to the base. The housing has a storage chamber extending to an opening. A cover is coupled to housing over the opening and movable between an open position allowing access to the storage chamber and a closed position to close the opening. A battery housed in the storage chamber. The unit has a pair of arms that can move between an extended position out of the storage chamber and a retracted position within the storage chamber. Photovoltaic solar panel(s) have opposite ends pivotally coupled to the pair of arms via pivot joints. The unit has a controller operable to move the housing and the photovoltaic solar panels to track the sun. The controller can rotate the housing relative to the base to track an azimuth position of the sun and/or rotate the photovoltaic solar panels about the pivot joints when the arms are in the extended position to track an elevation position of the sun. The photovoltaic solar panels are electrically connected to the battery, which can store electricity generated by the photovoltaic solar panels.

In some aspects, the techniques described herein relate to a solar energy unit, including: a base configured to contact and be supported on a ground surface; a housing disposed vertically above and being rotatably coupled to the base, the housing having a storage chamber extending to an opening at an end of the housing opposite the base; a cover coupled to housing over the opening and movable between an open position allowing access to the storage chamber and a closed position to close the opening; a pair of arms configured to move between an extended position out of the storage chamber when the cover is in the open position and a retracted position within the storage chamber; and a plurality of photovoltaic solar panels pivotally coupled to the pair of arms via pivot joints and about a pivot axis, one or more of the plurality of photovoltaic solar panels being slidable along a parallel plane relative to another of the plurality of photovoltaic solar panels.

In some aspects, the techniques described herein relate to a solar energy system including one or more solar energy units, including: a base configured to contact and be supported on a ground surface; a housing disposed vertically above and being rotatably coupled to the base, the housing having a storage chamber extending to an opening at an end of the housing opposite the base; a cover coupled to housing over the opening and movable between an open position allowing access to the storage chamber and a closed position to close the opening; a battery housed in the storage chamber; a pair of arms configured to move between an extended position out of the storage chamber when the cover is in the open position and a retracted position within the storage chamber; one or more photovoltaic solar panels having opposite ends pivotally coupled to the pair of arms via pivot joints; and a controller operable to move the housing and the photovoltaic solar panels to track the sun, the controller operable to rotate the housing relative to the base to track an azimuth position of the sun; rotate the photovoltaic solar panels about the pivot joints when the arms are in the extended position to track an elevation position of the sun, wherein the one or more photovoltaic solar panels are electrically connected to the battery, the battery configured to store electricity generated by the one or more photovoltaic solar panels.

In some aspects, the techniques described herein relate to a standalone solar energy unit, including: a base configured to contact and be supported on a ground surface; a housing disposed vertically above and being rotatably coupled to the base, the housing having a storage chamber extending to an opening at an end of the housing opposite the base; a cover coupled to housing over the opening and movable between an open position allowing access to the storage chamber and a closed position to close the opening; a battery housed in the storage chamber; a pair of arms configured to move between an extended position out of the storage chamber when the cover is in the open position and a retracted position within the storage chamber; one or more photovoltaic solar panels having opposite ends pivotally coupled to the pair of arms via pivot joints; and a controller operable to move the housing and the photovoltaic solar panels to track the sun, the controller operable to rotate the housing relative to the base to track an azimuth position of the sun; rotate the photovoltaic solar panels about the pivot joints when the arms are in the extended position to track an elevation position of the sun, wherein the one or more photovoltaic solar panels are electrically connected to the battery, the battery configured to store electricity generated by the one or more photovoltaic solar panels.

### BRIEF DESCRIPTION OF THE DRAWINGS

FIG. 1 shows perspective schematic view of a solar energy unit in a closed configuration.

FIG. 2 shows a perspective schematic view of a solar energy unit in a closed configuration.

FIG. 3 shows a perspective schematic view of the solar energy unit illustrated in FIG. 2 in a partially open configuration.

FIG. 4 shows another perspective schematic view of the solar energy unit illustrated in FIG. 2 in another partially open configuration.

FIG. 5 shows a perspective schematic view of the solar energy unit illustrated in FIG. 2 in an open configuration.

FIG. 6 shows a perspective schematic view of a solar energy unit in an open configuration.

FIG. 7 shows another perspective schematic view of a solar energy unit in an open configuration.

FIG. 8 shows a schematic side view of a solar energy unit.

FIG. 9 shows another perspective schematic view of the solar energy unit illustrated in FIG. 6 in an open configuration.

FIG. 10 shows a block diagram illustrating the electronics of a solar energy unit.

FIG. 11 shows a block diagram illustrating the operation of a solar energy unit.

FIG. 12 shows a block diagram illustrating a solar energy system.

FIG. 13A shows a flow-chart depicting a method for delivering power from the solar energy unit to an electric vehicle.

FIG. 13B shows a flow-chart depicting a method for delivering power from the solar energy unit to a home.

### DETAILED DESCRIPTION

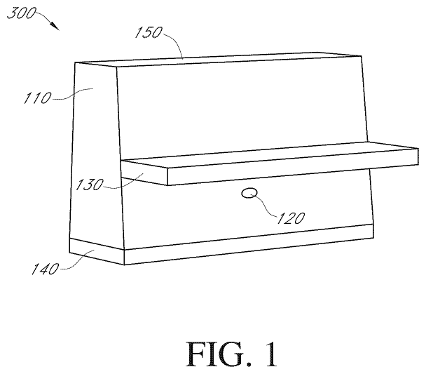

FIGS. 1-13B illustrate a system for capturing, storing, and delivering solar power using prefabricated and free-standing solar energy units. Advantageously, the units can be simple to install in a yard or on a patio. Multiple solar energy units can be linked to form a solar energy system. Each solar unit has photovoltaic panels (“PV panels”) to capture solar energy, a battery to store that energy, and a housing to store the PV panels (e.g., when not in use to capture solar energy). Since each unit can be prefabricated and free standing, the system is beneficially easy and quick to install. The housing beneficially can protect the PV panels in bad weather (e.g., rain, high winds, hail, etc.) and the housing can be visually appealing to, for example, blend in with lawn décor when not in use.

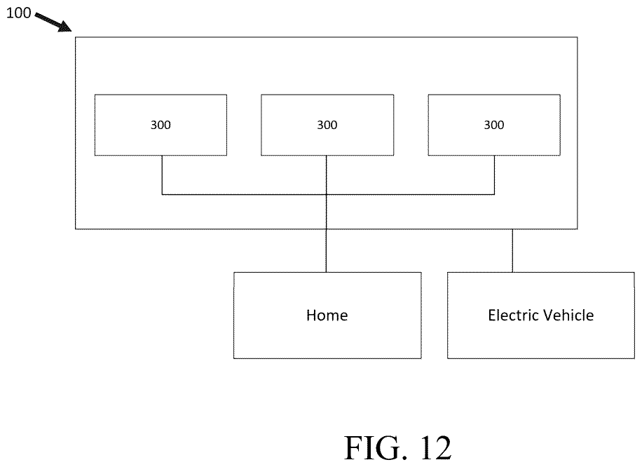

The solar energy system 100 (see FIG. 12) can include one or more (e.g., 1, 2, 3, 4, or more) solar energy units 300 (e.g., standalone solar energy unit). Each solar energy unit 300 can have a battery 190. In one implementation, each solar energy unit 300 can generate around 1.5 to 2.0 KW of electricity, such as 1.5 kW. The plurality of solar energy units 300 can, in one example, be in electrical communication with each other. In one implementation, the solar energy system 100 can include three solar energy units 300 that can, for example, power a house and/or provide power to a charger for an electric vehicle.

As shown in FIG. 1, each solar energy unit 300 can include a housing 110. The housing 110 can be made of concrete or another weatherproof material (e.g., metal, plastic, ceramic, etc.). In the closed configuration depicted in FIG. 1, the housing 110 stores a plurality PV panels 180 (in a storage chamber, not shown). The PV panels 180 can retract (e.g., automatically) into the housing 110. The housing 110 can be positioned over (e.g., vertically above) a base 140, the housing 110 rotatably coupled to the base 140 via rotational actuator 145. The base 140 can sit on a ground surface (e.g., of a patio or in a yard). As illustrated, the housing 110 has a cover 150. The cover 150 can attach to the housing 110 with a hinge or another method of attachment (e.g., snap fit, slide fit, latch, or other attachment method). The cover 150 can be made of sheet metal or another weatherproof material (e.g., plastic, concrete, or ceramic). The cover 150 can inhibit (e.g., prevent) water (or debris, such as dirt, dust) from entering the housing 110. The cover 150 beneficially protects the PV panels 180 and all other internal components from bad weather while in the closed configuration. In one example, the housing 110 can optionally include a bench 130. In other examples, the bench is excluded. In some examples, the housing 110 can include other features that blend in with lawn décor (e.g., flower boxes or yard tool storage). The housing 110 can have an electric plug 120. The electric plug 120 can optionally be positioned under the bench 130 to advantageously protect the electric plug from weather elements. In other examples, the solar energy unit 300 may have more than one electric plug 120, which may be positioned in any other surface of the housing 110. The housing 110 can (optionally) enclose a battery 190. The housing 110 and/or battery 190 can provide ballast for the solar energy unit 300. The ballast can beneficially increase the stability of the solar energy unit 300 to inhibit (e.g., prevent) the solar energy unit 300 from tipping over (e.g., during operation, due to wind load on the solar energy unit 300). The housing 110 can further include self-ballasting and cleaning elements. In some implementations, wiper blades can be attached to each of the PV panels 180 and actuated to move across the PV panel 180 to clean it. In another implantation, the PV panel(s) 180 are cleaned (e.g., to remove dust, debris from the panel(s) 180) when retracted into the housing 110 (e.g., via a wiper blade, sponge, brush or other material that contacts the PV panel(s) 180, for example as the pass into the housing 110 when retracted). For example, the same actuator that actuates the retraction of the PV panel(s) 180 actuates the cleaning element (e.g. brush) to clean the PV panel(s) 180.

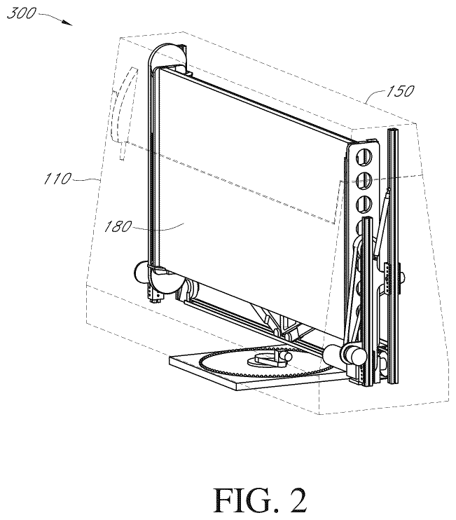

FIG. 2 shows one example of a solar energy unit 300. As illustrated, each solar energy unit 300 can include a housing 110, which is translucent in the figure for illustrative purposes. The housing 110 can be made of concrete or another weatherproof material (e.g., metal, plastic, ceramic, etc.). In the closed configuration depicted in FIG. 1, the housing 110 stores a plurality PV panels 180. The PV panels 180 can retract (e.g., automatically) into the housing 110. As illustrated, the housing 110 has a cover 150. The cover 150 can attach to the housing 110 with a hinge or another method of attachment (e.g., snap fit, slide fit, latch, or other attachment method). The cover 150 can be made of sheet metal or another weatherproof material (e.g., plastic, concrete, or ceramic). The cover 150 can inhibit (e.g., prevent) water (or debris, such as dirt, dust) from entering the housing 110. The cover 150 beneficially protects the PV panels 180 and all other internal components from bad weather while in the closed configuration.

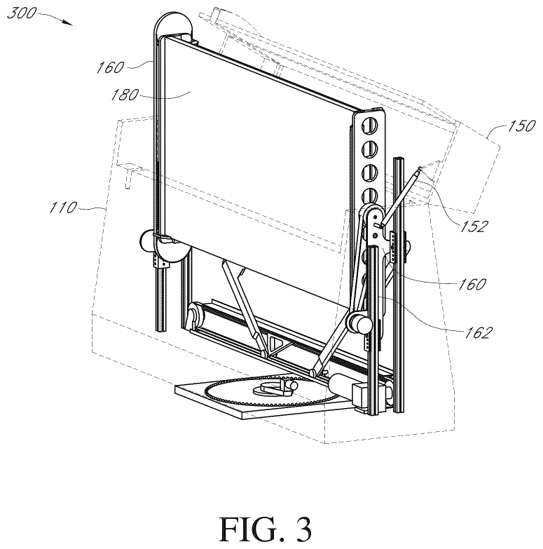

FIG. 3 illustrates the solar energy unit 300 between the closed configuration and the open configuration. The cover 150 can be opened to allow arms 160 (e.g., a pair of spaced apart and generally parallel arms) to extend out of the housing 110 (e.g., in a telescoping manner). In one example, one or both of the arms 160 can be pneumatically operated to drive the extension of the arms 160. In another example, one or both of the arms 160 can be hydraulically operated to drive the extension of the arms 160. In another example, one or both of the arms 160 can be actuated via a linear actuator (e.g., lead screw mechanism) to drive the extension of the arms 160. The cover 150 can be attached to a first end of a pivot rod 152. The pivot rod 152 can attach at a second end to the arm 160. The cover 150 can have a hinged connection to the housing 110. The pivot rod 152 can link the opening of the cover 150 to the extension of the arms 160, guiding the cover 150 from a closed position to an open position. In bad weather, the arms 160 can retract (e.g., automatically retract) into the housing 110 to retract the PV panels 180 into the housing 110, and to automatically close the cover 150 via the pivot rod 152, which is pulled into the housing 110 by the retraction of the arms 160 into the housing 110.

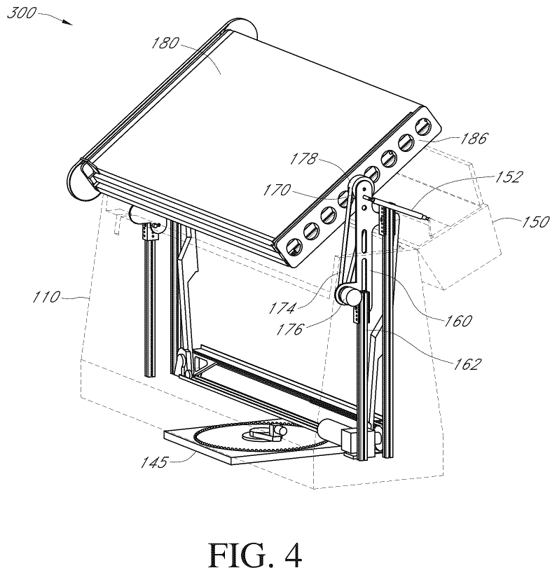

FIG. 4 illustrates the solar energy unit 300 once the arms 160 are fully extended. Once the arms 160 fully extended, the PV panels 180 can rotate around a pivot joint 170 (e.g., a frame 186 that holds the PV panels 180 can rotate about the pivot joint 170), such as via a belt or chain 174 driven by a motor 176 that rotates a pulley or gear 178 attached to the frame 186 of the PV panels 180 at the pivot joint 170. The cover 150 is shaped such that it will not interfere with this rotation.

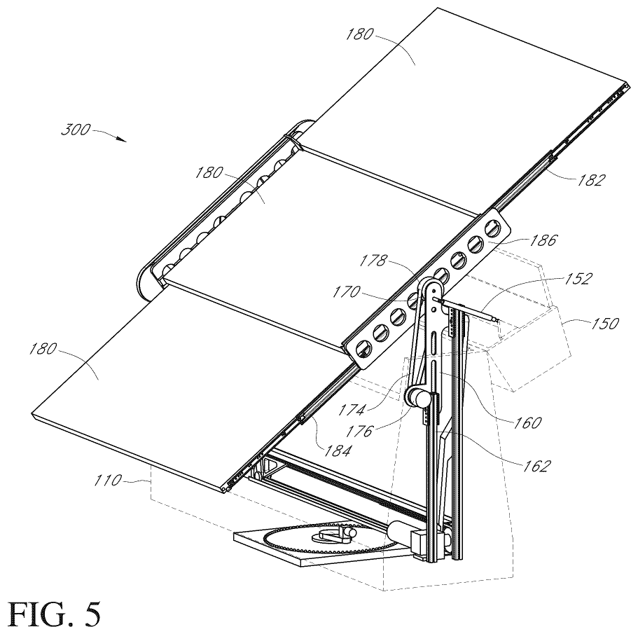

FIG. 5 illustrates the solar energy unit 300 with the PV panels 180 extended (e.g., with one or more PV panels 180 extended relative to the frame 186 of the PV panels 180). The PV panels 180 can include three PV panels 180. In other examples, at least one (e.g., 1, 2, 3, or 4) PV panels 180 may be included in the solar energy unit 300. In the closed position, the panels 180 are stacked on top of each other (e.g., parallel to each other). Once the arms 160 are fully extended and the PV panels 180 have rotated around the pivot joint 170, the first PV panel 180 can slide along a rail 182 in one direction (in a parallel plane to the other PV panels 180). The third PV panel 180 can slide along a rail 184 in an opposite direction from the direction the first PV panel 180 moves (in a parallel plane to the other PV panels 180). Once the first PV panel 180 has slid along the rail 182 and the third PV panel 180 has slid along the rail 184, the surface area of all three PV panels 180 are exposed and available to absorb solar energy. Advantageously, this arrangement of PV panels 180 inhibits (e.g., prevents) one PV panel 180 from casting a shadow on another of the PV panels 180 that may otherwise decrease the power generating capacity of the PV panels 180, and therefore the solar energy unit 300.

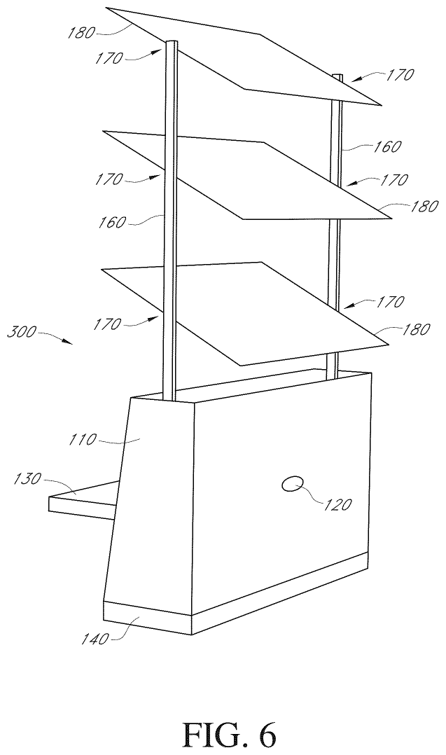

FIG. 6 illustrates another example of a solar energy unit 300. The solar energy unit 300 in an open configuration. In the open configuration, the cover 150 can be opened to allow arms 160 (e.g., a pair of spaced apart and generally parallel arms) to extend out of the housing 110 (e.g., in a telescoping manner). In bad weather, the arms 160 can retract (e.g., automatically retract) into the housing 110 to retract the PV panels 180 into the housing 110. The PV panels 180 can be attached to the arms 160 with pivot joints 170. As illustrated, the system 100 includes three PV panels 180. In other examples, at least one (e.g., 1, 2, 3, or 4) PV panels 180 may be included in the solar energy unit 300.

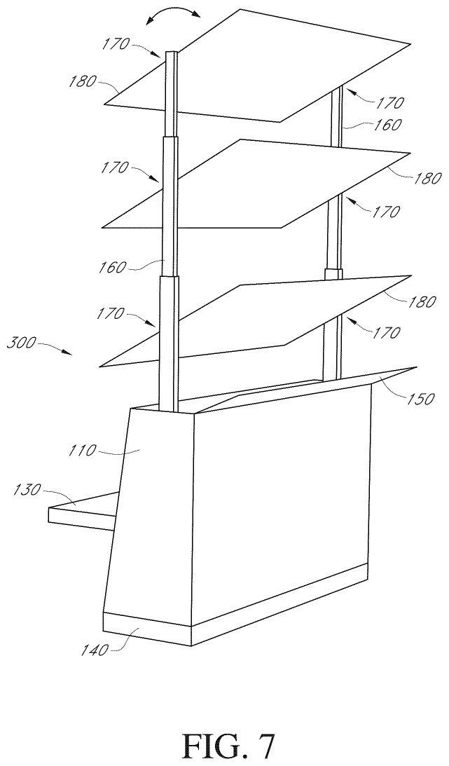

FIG. 7 illustrates another perspective view of the solar energy unit 300. As illustrated in FIG. 7, The arms 160 can include a plurality of segments (e.g., 1, 2, 3, 4, or more). These segments can move in a telescoping manner to extend out of, or retract into, the housing 110. The segments can be rails, tubes, or have other suitable shapes. In one example, the arms 160 can extend linearly using nesting slides. The arms 160 can extend using other mechanisms, for example a pulley system, ball screw linear actuator, or other forms of linear actuators known in the art. The pivot joints 170 can each be positioned on a segment of an arm 160. In one example the PV panels 180 can be attached to the pivot joints 170 at a midpoint axis of each PV panel 180.

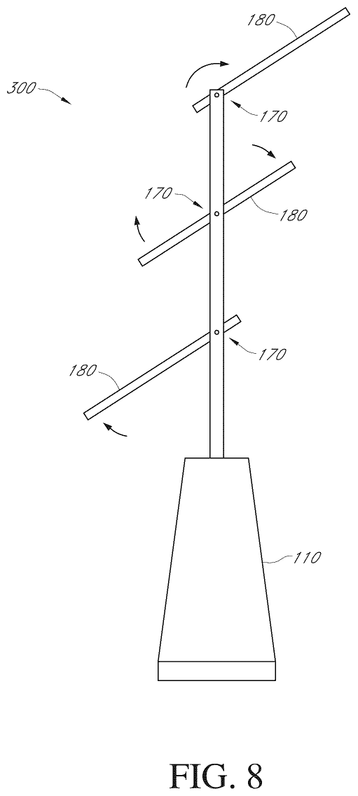

FIG. 8 illustrates another example of the solar energy unit 300. As shown, the PV panels 180 can be attached to the pivot joints 170 at staggered or offset axes on each PV panel 180. As illustrated in FIG. 4, a first PV panel 180 (e.g., lowest PV panel) may rotate around an axis near a first end of the first PV panel 180, one or more middle PV panels 180 may rotate around axes near the midpoint of each middle PV panel 180, and a last PV panel 180 (e.g., highest PV panel) may rotate around an axis near a second end of the last PV panel 180 (the second end being opposite the first end), such that the PV panels 180 can be staggered fore to aft relative to each other as they pivot about the pivot joints along their pivot axes. This arrangement advantageously can inhibit (e.g., reduce, minimize, prevent) shadows the PV panels 180 cast on each other that may otherwise decrease the power generating capacity of the PV panels 180, and therefore the solar energy unit 300.

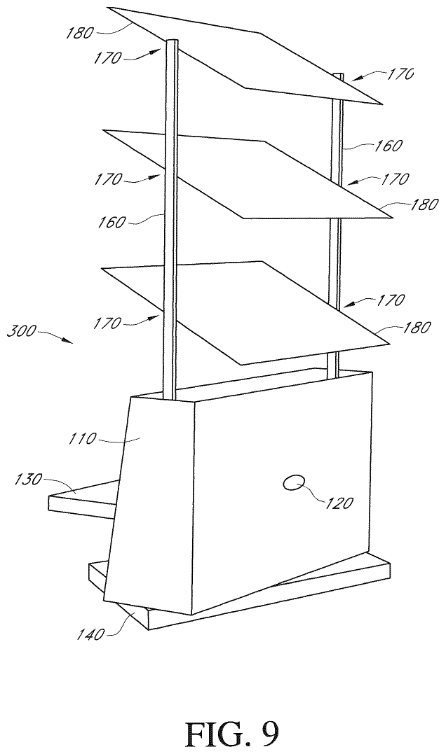

As best illustrated in FIG. 9, the cover 150 can rotate open (e.g., via one or more hinges) or open in other ways (e.g., slide, roll, or retract). The opening of the cover 150 can be manually or automatically actuated.

When retracting to the closed position illustrated in FIGS. 1 and 2, the pivot joints 170 can rotate the PV panels 180 to an acute angle (e.g., 0, 5, 10, 15, 20, 25, or 30 degrees) relative to the arms 160 so that the PV panels can fit within the housing 110. While in the open position illustrated in FIGS. 5 and 7, the pivot joints 170 can rotate the PV panels 180 to an oblique angle (e.g., 60, 65, 70, 75, 80, 85, or 90 degrees), relative to the arms 160, so that the PV panels 180 can expose their surface area to the sun. The pivot joints 170 can be manually and/or automatically actuated. In some examples, each PV panel 180 can be actuated by one driving pivot joint 170 connected to one arm and a second pivot joint 170 which can support the PV panel 180 (e.g., with a bushing or bearing). In other examples, each PV panel 180 can be actuated by a pair of driving pivot joints 170.

In some examples, the pivot joints 170 can rotate to track the sun (in an elevation direction) while in the open position. In some examples, the pivot joints 170 can rotate to avoid shadows one PV panel 180 casts on another PV panel 180. The pivot joints 170 of the PV panels 180 can operate independently or together so that the PV panels 180 move independently of each other or move simultaneously in a synchronized manner, respectively.

As illustrated in FIG. 9, the housing 110 can rotate on the base 140 (e.g., via an azimuth actuator). This rotation can apply to any example described herein. The housing 110 can be manually and/or automatically actuated. The housing 110 can rotate relative to the base 140 to track the azimuth of the sun.

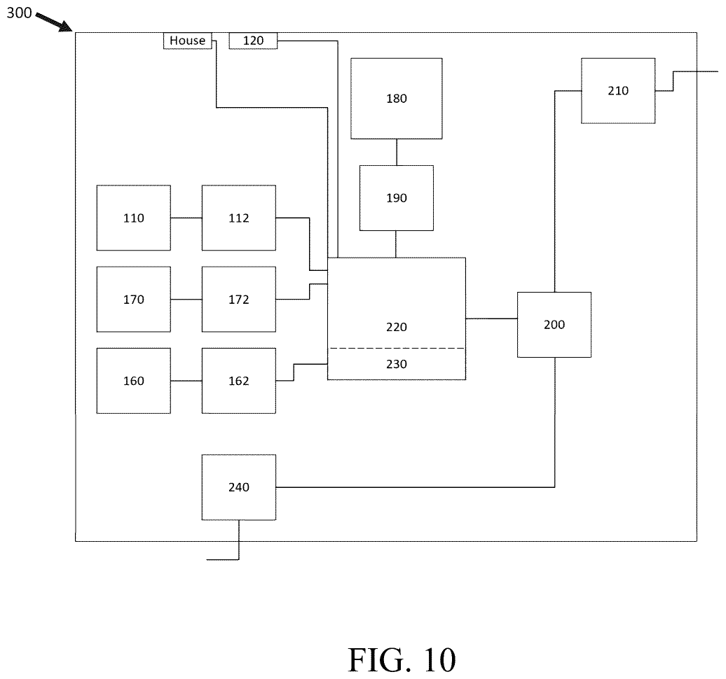

FIG. 10 shows a block diagram depicting the electronics system of a solar energy unit 300. The electronic system can apply to any example described herein. A controller 220 (e.g., one or more processors, central processing unit or CPU) communicates with a battery 190. The controller also communicates with a memory 230 that can store information sensed by one or more sensors 240 (e.g., light, heat, GPS, compass, sun sensor, such as such parameter measurements over a period of time) and one or more receivers/transmitters 210. The sensors 240 and receivers/transmitters 210 can communicate information to software 200 which can then communicate the information to the controller 220. In one implementation, the software 200 is stored on the memory 230. The controller 220 can communicate instructions from the software 200 with a base actuator 112 (e.g., azimuth actuator), and/or a linear arm actuator 162, and/or a pivot actuator 172 (e.g., elevation actuator). Additionally, the controller 220 can communicate instructions from the software 200 with an electric plug 120 and/or the main power line of a home.

Receiver/transmitter 210 can communicate wirelessly with a remote electronic device (e.g., a mobile electronic device such as a smartphone, tablet computer, laptop computer, a desktop computer, remote server, cloud server) via a wireless communication system such as Wi-Fi (e.g., IEEE 802.11 standard) and/or short-range wireless communication standard (e.g., BLUETOOTH®) and/or radio antenna via which information (e.g., GPS, sensed parameter data, weather data, and operational parameters etc.) can be communicated wirelessly (e.g., from the cloud, from a remote electronic device, such as a smartphone, etc.). In one implementation, the solar energy unit 300 can be set up using an app on a smartphone or tablet computer. In one example, the direction of the installation of the solar energy unit 300 (e.g., based on information from a compass and/or the GPS sensor of the unit 300) can be used to find the azimuth to operate the solar energy unit 300. Optionally, information from a sun sensor of the solar energy unit 300 can be used (e.g., by the app) to identify the preferred or optimal orientation (e.g., azimuth and/or elevation) for the PV panels 180. In another optional example, the preferred or optimal orientation (e.g., azimuth and/or elevation) for the PV panels 180 to achieve maximum power generation can be determined (e.g., using a maximum power search functionality of the electronics in the solar energy unit 300, such as by changing the azimuth and/or elevation angle of the PV panels 180 and comparing measured power in the different orientations).

The receiver/transmitter 210 can receive communications from a remote electronic device (e.g., a mobile electronic device such as a smartphone, tablet computer, laptop computer, a desktop computer, remote server, cloud server) instructing the operation of the solar energy unit 300. The receiver/transmitter 210 can communicate operational instructions to the software 200 which can then communicate the instructions to the controller 220 to, for example, control the base actuator 112 (e.g., azimuth actuator) and/or linear arm actuator 162 and/or pivot actuator 172 (e.g. elevation actuator).

The receiver/transmitter 210 can communicate operational information (e.g., sensed information, operating conditions, battery charge, etc.) to a remote electronic device (e.g., a mobile electronic device such as a smartphone, tablet computer, laptop computer, a desktop computer, remote server, cloud server, etc.).

The base actuator 112 can actuate the housing 110 relative to the base 140. The linear arm actuator 162 can actuate the arms 160. The pivot actuator 172 can rotate the PV panels 180 around pivot joints 170. The controller 220 can automatically control one, all, none, or any combination of the base actuator 112, linear arm actuator 162, and pivot actuator 172 based on the information received by the sensors 240 and/or the receiver/transmitter 210. Additionally, the controller 220 can automatically control the cover 150 (e.g., to open or close).

For example, the sensors 240 can communicate the location of the sun relative to the solar energy unit 300 to the controller 220 (e.g., with a temperature or light sensor). The controller 220 can actuate the base actuator 112 and the pivot actuator 172 based on the sensor 240 information so that the PV panels 180 track both the azimuth of the sun and the angle of the sun in the sky.

In another example, the receiver/transmitter 210 can communicate current or future weather information to the controller 220. The controller 220 can actuate the linear arm actuator 162 and pivot actuator 172 based on the weather information so that the arms 160 can be retracted into the housing 110 and the cover 150 can be closed over the housing 110 when bad weather (e.g., a storm, high wind event) is impending.

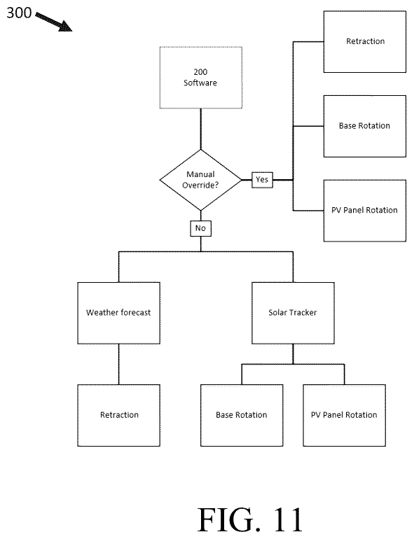

As illustrated in FIG. 11, the retraction, base rotation, and PV panel rotation as described above can be controlled by software 200. The software 200 can be applied to any example described herein. The software 200 can use a solar tracker (e.g., photosensors, heat sensors, and/or date-time based algorithms) to control one or both of the azimuth base rotation via the base actuator 112 and the PV panel rotation, via the pivot actuator 172, of the solar energy unit 300. The software 200 can also receive weather forecast data from the receiver/transmitter 210 and retract the arms 160, via the linear arm actuator 162, if bad weather (e.g., rain, hail, high winds) is forecast. The software 200 can also allow a user to manually override the software's 200 automatic control of the retraction, base rotation, or PV panel rotation. For example, a user can override the retraction software 200 to retract the PV panels on a sunny day. In another example, a user can override the base rotation while allowing the software 200 to control the PV panel rotation. This may be advantageous while using the electric vehicle charging capabilities of the system, as described herein.

FIG. 12 illustrates the solar energy system 100. The solar energy system 100 can include one or more (e.g., 1, 2, 3, 4, or more) solar energy units 300. The solar energy system 100 can apply to any example of the solar energy unit 300 described herein. The plurality of solar energy units 300 can be in electrical communication with each other. The solar energy system 100 can be in electrical communication with a home and/or an electric vehicle. In one implementation, the solar energy system 100 can include three solar energy units 300 to power a house. In another implementation the solar energy system 100 can have the one or more (e.g., multiple) solar energy units 300 connected in series (e.g., daisy chained together). In some examples, not all of the solar energy units 300 in the system can have a battery 190 for energy storage. Each of the solar energy units 300 can have an electrical connector 120 on both sides of the housing 110 (e.g., one electrical connector can be a power-in connector, and the other electrical connector can be a power-out connector). One electrical connector 120 can be a male connector and the other electrical connector 120 can be a female connector, allowing the multiple solar energy units 300 to be connected in series via cables that extend from an electrical connectors 120 in one solar energy unit 300 to an electrical connector 120 in another solar energy unit 300. The last of the solar energy units 300 can have the battery 190 and can connect to a house or car charger. In one example, the home mains power can optionally have a wireless sensor (e.g., UL compliant) via which delivered power from the system 100 can be adjusted (e.g., between 0 energy provided by the system 100 so all power to the house is provided by the grid, and 100 energy provided by the system 100 so 0 energy is provided to the house from the grid).

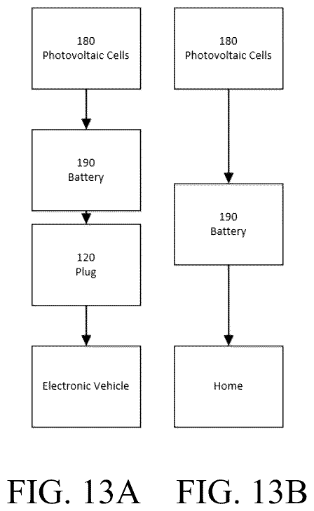

FIGS. 13A and 13B show flow charts describing how a solar energy unit 300 captures, stores, and delivers energy. This can apply to any example of the solar energy unit 300 described herein. As illustrated in FIG. 13A, the PV panels 180 capture solar energy and store that energy in a battery 190 (located in the housing 110). An electric vehicle can be plugged into one solar energy unit 300 of the system 100 via the electric plug 120, then power from the battery 190 can be delivered to the electric vehicle. For example, the system 100 can capture solar energy with the PV panels 180 during the day and store the energy in the battery 190 in the housing 110. At night, a user can charge their electric vehicle with power stored in the battery 190 by connecting the charging cable to the housing 110 of one or more of the solar energy units 300 (via the electric plug 120). As illustrated in FIG. 13B, the PV panels 180 capture solar energy and store that energy in a battery 190. The solar energy unit 300 is connected to a main powerline for a home and power from the battery 190 can be delivered to the home. This advantageously reduces the energy the house needs to pull from the power grid. The system 100 can include a sensor on the house main line that can restrict the system 100 from injecting power into the grid.

While certain embodiments of the inventions have been described, these embodiments have been presented by way of example only and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of the stated amount. As another example, in certain embodiments, the terms “generally parallel” and “substantially parallel” refer to a value, amount, or characteristic that departs from exactly parallel by less than or equal to 15 degrees.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed devices.

What is claimed is:

1. A solar energy unit, comprising:
a base configured to contact and be supported on a ground surface;
a housing disposed vertically above and being rotatably coupled to the base, the housing having a storage chamber extending to an opening at an end of the housing opposite the base;
a cover coupled to housing over the opening and movable between an open position allowing access to the storage chamber and a closed position to close the opening;
a pair of arms configured to move between an extended position out of the storage chamber when the cover is in the open position and a retracted position within the storage chamber; and
a plurality of photovoltaic solar panels pivotally coupled to the pair of arms via pivot joints and about a pivot axis, one or more of the plurality of photovoltaic solar panels being slidable along a parallel plane relative to another of the plurality of photovoltaic solar panels, the plurality of photovoltaic solar panels being configured to pivot relative to the pair of arms to allow storage of the photovoltaic solar panels and arms in the storage chamber of the housing.

2. The solar energy unit of claim 1, a battery housed in the storage chamber, the plurality of photovoltaic solar panels electrically connected to the battery.

3. The solar energy unit of claim 1, wherein the plurality of photovoltaic solar panels are three photovoltaic solar panels, two of the photovoltaic solar panels being slidable along parallel planes relative to a third of the photovoltaic solar panels.

4. The solar energy unit of claim 1, wherein the cover is operatively coupled to one of the pair of arms such that extension of the pair of arms out of the housing moves the cover to an open position relative to the housing and retraction of the pair of arms into the housing moves the cover to a closed position relative to the housing.

5. The solar energy unit of claim 1, wherein the plurality of photovoltaic solar panels are pivotally coupled to the pair of arms via a frame that holds the plurality of photovoltaic solar panels, the frame pivotally coupled to the pair of arms at a pivot joint.

6. The solar energy unit of claim 5, wherein the frame comprises one or more linear guides, one or more of the plurality of photovoltaic solar panels being slidably coupled to the frame via the one or more linear guides.

7. The solar energy unit of claim 5, further comprising an actuator operable to rotate the frame about the pivot joints.

8. The solar energy unit of claim 7, wherein the actuator includes an electric motor, a pulley or gear attached to the frame about one of the pivot joints, and a belt or chain extending between and coupling an output shaft of the electric motor and the pulley or gear, wherein rotation of the motor in one direction causes frame to pivot in a first direction relative to the pair of arms and wherein rotation of the motor in an opposite direction causes the frame to pivot in a second direction relative to the pair of arms that is opposite to the first direction.

9. The solar energy unit of claim 1, further comprising:
a controller operable to move the housing and the photovoltaic solar panels to track the sun, the controller operable to:
rotate the housing relative to the base to track an azimuth position of the sun; and
rotate the photovoltaic solar panels about the pivot joints when the arms are in the extended position to track an elevation position of the sun.

10. A solar energy unit, comprising:
a base configured to contact and be supported on a ground surface;
a housing disposed vertically above and being rotatably coupled to the base, the housing having a storage chamber extending to an opening at an end of the housing opposite the base;
a pair of arms configured to move between an extended position out of the storage chamber and a retracted position within the storage chamber; and
a plurality of photovoltaic solar panels pivotally coupled to the pair of arms via pivot joints and about a pivot axis, one or more of the plurality of photovoltaic solar panels being slidable along a parallel plane relative to another of the plurality of photovoltaic solar panels, the plurality of photovoltaic solar panels being configured to pivot relative to the pair of arms to allow storage of the photovoltaic solar panels and arms in the storage chamber of the housing.

11. The solar energy unit of claim 10, a battery housed in the storage chamber, the plurality of photovoltaic solar panels electrically connected to the battery.

12. The solar energy unit of claim 10, wherein the plurality of photovoltaic solar panels are three photovoltaic solar panels, two of the photovoltaic solar panels being slidable along parallel planes relative to a third of the photovoltaic solar panels.

13. The solar energy unit of claim 10, further comprising:
a controller operable to move the housing and the photovoltaic solar panels to track the sun, the controller operable to:
rotate the housing relative to the base to track an azimuth position of the sun; and
rotate the photovoltaic solar panels about the pivot joints when the arms are in the extended position to track an elevation position of the sun.

14. A solar energy unit, comprising:
a base configured to contact and be supported on a ground surface;
a housing disposed vertically above and being rotatably coupled to the base, the housing having a storage chamber extending to an opening at an end of the housing opposite the base;
a pair of arms configured to move between an extended position out of the storage chamber and a retracted position within the storage chamber; and
a plurality of photovoltaic solar panels pivotally coupled to the pair of arms via pivot joints and about a pivot axis, the plurality of photovoltaic solar panels being configured to pivot relative to the pair of arms to allow storage of the photovoltaic solar panels and arms in the storage chamber of the housing.

15. The solar energy unit of claim 14, a battery housed in the storage chamber, the plurality of photovoltaic solar panels electrically connected to the battery.

16. The solar energy unit of claim 14, further comprising an actuator operable to rotate the plurality of photovoltaic solar panels about the pivot joints.

17. The solar energy unit of claim 14, further comprising:
a controller operable to move the housing and the photovoltaic solar panels to track the sun, the controller operable to:
rotate the housing relative to the base to track an azimuth position of the sun; and
rotate the photovoltaic solar panels about the pivot joints when the arms are in the extended position to track an elevation position of the sun.

18. The solar energy unit of claim 14, wherein the pair of arms include telescoping slide segments.

19. The solar energy unit of claim 14, wherein the plurality of photovoltaic solar panels have offset pivot axes that inhibit one photovoltaic solar panel casting a shadow on another photovoltaic solar panel.

20. The solar energy unit of claim 15, wherein the housing has an electrical connector electrically connected to the battery in the storage chamber and via which electricity stored in the battery can be transferred from the solar energy unit.
